(19) United States
(12) Patent Application Publication
(10) Pub. No.: US 2018/0302740 A1
(43) Pub. Date: Oct. 18, 2018

(54) POSITIONING METHOD AND DEVICE

(71) Applicant: AthenTek Incorporated, Taipei City (TW)

(72) Inventors: Ivy H. Tseng, Taipei City (TW); David S. De Lorenzo, Palo Alto, CA (US); Jia Ming Tony Chang, Taipei City (TW); Shau-Shiun Jan, Tainan City (TW); Shu-Hua Tsao, Tainan City (TW); Pei-Yu Huang, Tainan City (TW)

(21) Appl. No.: 15/488,408

(22) Filed: Apr. 14, 2017

(51) Int. Cl. H04W 4/02; G01S 5/00; H04W 64/00; G01S 5/02; H04W 48/20; H04L 29/08

(52) U.S. Cl. CPC H04W 4/02; G01S 5/0009; H04W 64/003; H04L 29/08657; H04W 48/20; H04L 67/18; G01S 5/021

(57) ABSTRACT

A positioning method and system are provided. The positioning method includes the steps of utilizing at least one electronic device to establish a calibration database corresponding to an irregular grid of reference location points which are defined in an environment; utilizing a mobile device to detect Wi-Fi access points in the environment; utilizing the mobile device to estimate the signal strengths of the detected Wi-Fi access points to generate an estimated result; utilizing a positioning terminal to compare the estimated result and data stored in the calibration database by a weighed K-Nearest neighbor location algorithm to generate a comparison result; and utilizing the positioning terminal to estimate the location of the mobile device according to the comparison result.

### BACKGROUND OF THE INVENTION

### Field of the Invention

The invention generally relates to positioning technology, and more particularly to a positioning method for estimating the location of a mobile device according to a calibration database through a weighed K-Nearest neighbor location algorithm.

### Description of the Related Art

Recently, mobile communication devices are becoming more popular. These include cellular telephones, portable navigation units, smartphones, tablets, laptop computers, and personal digital assistants, for example. The positioning technologies used in mobile communication devices are also becoming more popular.

For example, Global Positioning Systems (GPS) are applied to many kinds of electrical devices such as mobile phones and the navigation systems used in cars for outdoor position estimation. A GPS receives satellite signals and positions the electrical device which has the GPS receiver according to its relative location to determine the location of the electrical device. Users can also use the navigation program in the electrical device for planning and navigation operations.

However, when a GPS device is being operated in an indoor environment, or when satellite signals are interfered with or sheltered (such as when the device is in a tunnel or under a shed), the GPS may not receive the satellite signals, and GPS service is interrupted. Thus, a positioning method with better accuracy is needed for mobile communication devices in an indoor environment.

### BRIEF SUMMARY OF THE INVENTION

A positioning method and system are provided to overcome the problems mentioned above.

An embodiment of the invention provides a positioning method. The positioning method comprises the steps of utilizing at least one electronic device to establish a calibration database corresponding to an irregular grid of reference location points which are defined in an environment; utilizing a mobile device to detect Wi-Fi access points in the environment; utilizing the mobile device to estimate signal strengths of the detected Wi-Fi access points to generate an estimated result; utilizing a positioning terminal to compare the estimated result and data stored in the calibration database by a weighed K-Nearest neighbor location algorithm to generate a comparison result; and utilizing the positioning terminal to estimate the location of the mobile device according to the comparison result.

In some embodiments of the invention, the electronic device is coupled to a Wi-Fi adapter.

In some embodiments of the invention, the positioning method further comprises the steps of collecting measurement information corresponding to all of the reference location points from the Wi-Fi adapter and establishing the calibration database according to the measurement information. In some embodiments of the invention, the measurement information comprises the time stamps, MAC addresses, and signal strengths.

In some embodiments of the invention, the positioning method further comprises the step of removing data corresponding to one Wi-Fi access point from the calibration database when the Wi-Fi access point is detected at partial reference location points and the number of partial reference location points is less than a threshold. In some embodiments of the invention, the positioning method further comprises the step of removing data corresponding to one Wi-Fi access point from the calibration database when the signal strength deviation of the Wi-Fi access point exceeds a threshold.

In some embodiments of the invention, the positioning method further comprises the steps of determining whether one of the MAC addresses in the calibration database is detected in one of the reference location points and storing the signal strength corresponding to the MAC address as one fingerprint of the reference location point if the MAC address is detected at the reference location point.

In some embodiments of the invention, the positioning method further comprises the step of calibrating the measurement information by setting the signal strength corresponding to the MAC address to a default value and setting the MAC address as one fingerprint of the reference location point if the MAC address is not detected in the reference location point.

In some embodiments of the invention, the positioning method further comprises the step of transforming the calibration database from the irregular grid of reference location points to a regular grid of reference location points using mathematical interpolation.

In some embodiments of the invention, at least one of the Wi-Fi access points is configured to provide network connectivity. In some embodiments of the invention, a parameter K for the weighed K-Nearest neighbor location algorithm is set in a range from 4 to 8. In some embodiments of the invention, a separation distance for the weighed K-Nearest neighbor location algorithm is the Manhattan distance.

In some embodiments of the invention, the positioning method further comprises the steps of determining whether a MAC address of one of the detected Wi-Fi access points matches any MAC address stored in the calibration database, and if the MAC address does not match any MAC address stored in the calibration database, discarding the MAC address of the detected Wi-Fi access point.

In some embodiments of the invention, the positioning method further comprises the steps of determining whether a MAC address stored in the calibration database is comprised in the estimated result; and if the MAC address stored in the calibration database is not comprised in the estimated result, setting the signal strength corresponding to the MAC address to a default value for the mobile device.

In some embodiments of the invention, the positioning method further comprises the step of setting the signal strength corresponding to one MAC address to a default value for the mobile device, if the MAC address of one of the detected Wi-Fi access points does not match any MAC address corresponding to one of the reference location points but the MAC address corresponds to another reference location point.

An embodiment of the invention provides a positioning system. The positioning system comprises a storage device, a mobile device and a positioning terminal. The storage device stores a calibration database corresponding to an irregular grid of reference location points which are defined in an environment, wherein the calibration database is established by at least one electronic device in advance. The mobile device detects Wi-Fi access points in the environment and estimates signal strengths of the detected Wi-Fi access points to generate an estimated result. The positioning terminal compares the estimated result and data stored in the calibration database by a weighed K-Nearest neighbor location algorithm to generate a comparison result and estimates the location of the mobile device according to the comparison result.

Other aspects and features of the invention will become apparent to those with ordinary skill in the art upon review of the following descriptions of specific embodiments of positioning communication methods and systems.

### BRIEF DESCRIPTION OF THE DRAWINGS

The invention will become more fully understood by referring to the following detailed description with reference to the accompanying drawings, wherein:

FIG. 1 is a block diagram of a positioning system 100 according to an embodiment of the invention;

FIG. 2 is a flow chart 200 illustrating the positioning method according to an embodiment of the invention;

FIG. 3 is a flow chart 300 illustrating step S210 according to an embodiment of the invention;

FIG. 4 is a flow chart 400 illustrating step S240 according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

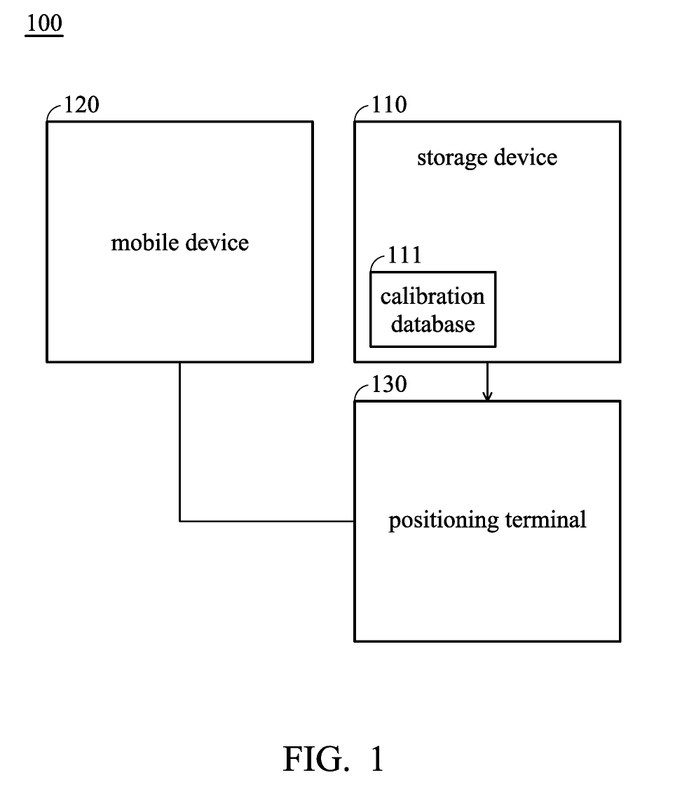

FIG. 1 is a block diagram of a positioning system 100 according to an embodiment of the invention. As shown in FIG. 1, the positioning system 100 may comprise a storage device 110, a mobile device 120, and a positioning terminal 130. Note that, in order to clarify the concept of the invention, FIG. 1 presents a simplified block diagram in which only the elements relevant to the invention are shown. However, the invention should not be limited to what is shown in FIG. 1.

In an embodiment of the invention, the storage device 110 may store a calibration database 111. In the embodiments of the invention, the storage device 110 may be configured in the positioning terminal 130 or not configured in the positioning terminal 130. Namely, the positioning terminal 130 can directly obtain the data of calibration database 111 from the storage device 110, or obtain the data of calibration database 111 from the storage device 110 through a network. In an embodiment of the invention, the calibration database 111 may be established in advance before the position estimation is performed, wherein the position estimation is applied to estimate the position of the mobile device 120.

In the embodiments of the invention, before the calibration database 111 is established, a plurality of reference location points are defined previously. The reference location points may be the different locations in an environment. In an embodiment of the invention, the reference location points are distributed as an irregular grid.

In the embodiments of the invention, a plurality of Wi-Fi access points are configured in advance for the position estimation. In one embodiment of the invention, at least one of the Wi-Fi access points is only configured to provide network connectivity and other Wi-Fi access points in the environment are configured for position estimation. In one embodiment of the invention, at least one of the Wi-Fi access points in the environment is configured to provide network connectivity and configured for position estimation.

In the embodiments of the invention, when the calibration database 111 is established, at least one electronic device (not shown in figures) will be utilized to collect measurement information corresponding to all of the reference location points from a Wi-Fi adapter. Each electronic device may be coupled with a Wi-Fi adapter, and store the measurement information in its storage device.

In one embodiment of the invention, when more than one electronic device is utilized, the electronic devices may be operated simultaneously.

In one embodiment of the invention, when more than one electronic device is utilized, a Wi-Fi adapter coupled to one of the electronic devices may be taken as a master device, and bias and scale factors of other Wi-Fi adapters coupled to other electronic devices may be modified according to the bias and scale factor of the master device.

In one embodiment of the invention, the Wi-Fi adapter may be placed on a turntable to reduce antenna anisotropy effects.

In an embodiment of the invention, the measurement information comprises time stamps, MAC addresses, and signal strengths, but the invention should not be limited thereto. Each of the MAC addresses corresponds to one Wi-Fi access point. That is to say, if the measurement information corresponding to one reference location point comprises a plurality of MAC addresses, it means that the Wi-Fi access points corresponding to these MAC addresses are near to, and therefore detectable at, the reference location point. In an embodiment of the invention, when the electronic device collects the measurement information corresponding to one reference location point, the electronic device may be placed at the reference location point over a period of time. The time stamps may be utilized to record the time points of the period of time. That is to say, for one reference location point, some of the collected signal strengths in different time points may correspond to the same MAC address in the period of time. Therefore, the electronic device may develop quantitative metrics for the collected signal strengths corresponding to the same MAC address. For example, the quantitative metrics could include a signal strength average value, a signal strength median value, a signal strength variance, and signal strength maximum and minimum received values.

In an embodiment of the invention, when one Wi-Fi access point corresponding to one MAC address is merely detected at partial reference location points (i.e., a few reference location points) and the number of these reference location points is less than a threshold (e.g., less than one-third of the total number of reference location points), the electronic device may remove the data corresponding to the Wi-Fi access point from the calibration database. That is to say, the electronic device may determine that the Wi-Fi access point is not one of the pre-configured Wi-Fi access points in the environment.

In an embodiment of the invention, when the signal strength standard deviation of one detected Wi-Fi access point corresponding to one MAC address exceeds a threshold (e.g., higher than 15-30 dB), the electronic device may remove the data corresponding to the Wi-Fi access point from the calibration database. It means that the variance of the signal strength measurements of the Wi-Fi access point at a reference point is too large, i.e. the signal strength of the Wi-Fi is not stable. Therefore, the electronic device may remove the data corresponding to the Wi-Fi access point from the calibration database 111. That is to say, the electronic device may determine that the Wi-Fi access point is not one of the pre-configured Wi-Fi access points in the environment.

After the measurement information of all reference location points is collected, the measurement information stored in the storage device of the electronic device may be calibrated, and then the calibrated measurement information may be stored as the data of the calibration database 111. The calibrated measurement information may be regarded as the fingerprints of the reference location points. The fingerprints of one reference location point may indicate all MAC addresses corresponding to the reference location point and indicate the average signal strengths corresponding to the MAC addresses corresponding to the reference location point; the fingerprints also may indicate other quantitative metrics corresponding to the MAC addresses corresponding to the reference location point. After the measurement information of all reference location points is collected, a list for all collected MAC address will be established in the calibration database 111.

In the embodiments of the invention, when the electronic device calibrates the measurement information for one reference location point, the electronic device may determine whether all of the MAC addresses in the list are detected at this reference location point. If one of the MAC addresses in the list is detected at this reference location point (i.e., the signal strength corresponding to the MAC address can be collected in the measurement information of the reference location point), the electronic device may store the signal strength corresponding to the MAC address as one fingerprint of the reference location point.

If one of the MAC addresses in the list is not detected at this reference location point (i.e., the signal strength corresponding to the MAC address cannot be collected in the measurement information of the reference location point), the electronic device may set the signal strength corresponding to the MAC address to a default value (e.g., −110 dB). In another embodiment, if one of the MAC addresses in the list is not detected at this reference location point (i.e., the signal strength corresponding to the MAC address cannot be found in the measurement information of the reference location point), the electronic device may set the signal strength corresponding to the MAC address to a non-numeric value (e.g., NaN). The electronic device may calibrate the measurement information for other reference location points accordingly. Therefore, in calibration database 111, all reference location points may correspond to the same MAC addresses (i.e., the data sizes for all reference location points are the same).

When the measurement information stored in the storage device of the electronic device has been calibrated, the electronic device may transmit to the positioning terminal 130 to establish the calibration database 111. The calibrated measurement information of the calibration database 111 will be able to be applied to estimate the position of the mobile device 120 in the environment.

In an embodiment of the invention, the electronic device may transform the calibration database 111 from the irregular grid of reference location points to a regular grid of reference location points according to mathematical interpolation.

In the embodiments of the invention, in the positioning stage, the mobile device 120 may detect the Wi-Fi access points in the environment, and then the mobile device 120 may estimate the signal strengths of the detected Wi-Fi access points to generate an estimated result. Then, the mobile device 120 may transmit the estimated result to the positioning terminal 130. In the embodiments of the invention, the estimated result may comprise the MAC addresses and the signal strengths of the Wi-Fi access points detected by the mobile device 120.

In the embodiments of the invention, when the positioning terminal 130 receives the estimated result from the mobile device 120, the positioning terminal 130 may compare the estimated result with the data (i.e., the calibrated measurement information) stored in the calibration database 111 by a weighed K-Nearest neighbor location algorithm to generate a comparison result.

In an embodiment of the invention, when the positioning terminal 130 compares the estimated result with the data stored in the calibration database 111, the positioning terminal 130 may determine whether the MAC addresses of the Wi-Fi access points detected by the mobile device 120 correspond to the MAC addresses stored in the calibration database 111. If one of the MAC addresses of the Wi-Fi access points detected by the mobile device 120 does not correspond to any MAC address stored in the calibration database 111 (i.e., the MAC address does not match any MAC address stored in the calibration database 111), the positioning terminal 130 may discard the MAC address. For example, if the MAC addresses stored in the calibration database 111 are MAC addresses A, B, and C and the MAC addresses of the Wi-Fi access points detected by the mobile device 120 are MAC addresses A, B, C, and D, then the positioning terminal 130 may discard the MAC address D.

In an embodiment of the invention, when the positioning terminal 130 compares the estimated result with the data stored in the calibration database 111, the positioning terminal 130 may further determine whether the MAC addresses stored in the calibration database 111 correspond to the MAC addresses of the Wi-Fi access points detected by the mobile device 120. If one of the MAC addresses stored in the calibration database 111 does not correspond to the MAC addresses of the Wi-Fi access points detected by the mobile device 120 (i.e., the MAC address does not match any MAC addresses of the Wi-Fi access points detected by the mobile device 120), the positioning terminal 130 may set the signal strength corresponding to this MAC address to a default value (e.g., −110 dB) for the mobile device 120. For example, if the MAC addresses stored in the calibration database 111 are MAC addresses A, B, and C and the MAC addresses of the Wi-Fi access points detected by the mobile device 120 are MAC addresses B and C, then the positioning terminal 130 may set the signal strength corresponding to the MAC address A to a default value for the mobile device 120. Namely, although the mobile device 120 does not detect the Wi-Fi access point corresponding to the MAC address A, the positioning terminal 130 may set signal strength of the Wi-Fi access point to a default value and set the Wi-Fi access point as one detected Wi-Fi access point of the mobile device 120.

In an embodiment of the invention, if one of the MAC addresses of the Wi-Fi access points detected by the mobile device 120 does not correspond to any MAC address corresponding to the reference location point but the MAC address does correspond to the MAC address corresponding to another reference location point, the positioning terminal 130 may set signal strength of the Wi-Fi access point to a default value (e.g., −110 dB) for the mobile device 120. Namely, the positioning terminal 130 may set the signal strength of the Wi-Fi access point to a default value and then set the Wi-Fi access point as one detected Wi-Fi access point of the mobile device 120 for the reference location point.

In the embodiments of the invention, when the positioning terminal 130 compares the estimated result with the data stored in the calibration database 111 by a weighed K-Nearest neighbor location algorithm, the positioning terminal 130 may use the weighed K-Nearest neighbor location algorithm to find the similar reference location points in the calibration database 111. When the positioning terminal 130 obtains the comparison result, the positioning terminal 130 may estimate the location of the mobile device 120 in the environment according to the comparison result. For example, the positioning terminal 130 may estimate that the location of the mobile device 120 is at a reference location point or approaches an area corresponding to some reference location points.

In an embodiment of the invention, a parameter K for the weighed K-Nearest neighbor location algorithm is set in a range from 4 to 8. In an embodiment of the invention, a separation distance for the weighed K-Nearest neighbor location algorithm is the Manhattan distance. In an embodiment of the invention, a low-pass smoothing filter or an in-store routing algorithm may be applied to the estimates to in order to improve estimation accuracy.

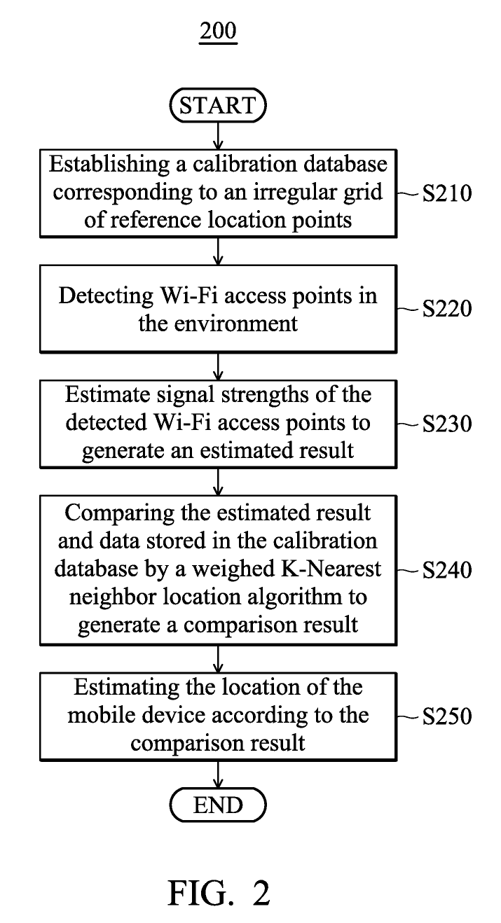

FIG. 2 is a flow chart 200 illustrating the positioning method according to an embodiment of the invention. The positioning method is applicable to the positioning system 100. In step S210, at least one electronic device may establish a calibration database 111 corresponding to an irregular grid of reference location points which are defined in an environment. In step S220, the mobile device 120 may detect Wi-Fi access points in the environment. In step S230, the mobile device 120 may estimate signal strengths of the detected Wi-Fi access points to generate an estimated result and transmit the estimated result to the positioning terminal 130. In step S240, the positioning terminal 130 may compare the estimated result and data stored in the calibration database 111 by a weighed K-Nearest neighbor location algorithm to generate a comparison result. In step S250, the positioning terminal 130 may estimate the location of the mobile device 120 according to the comparison result.

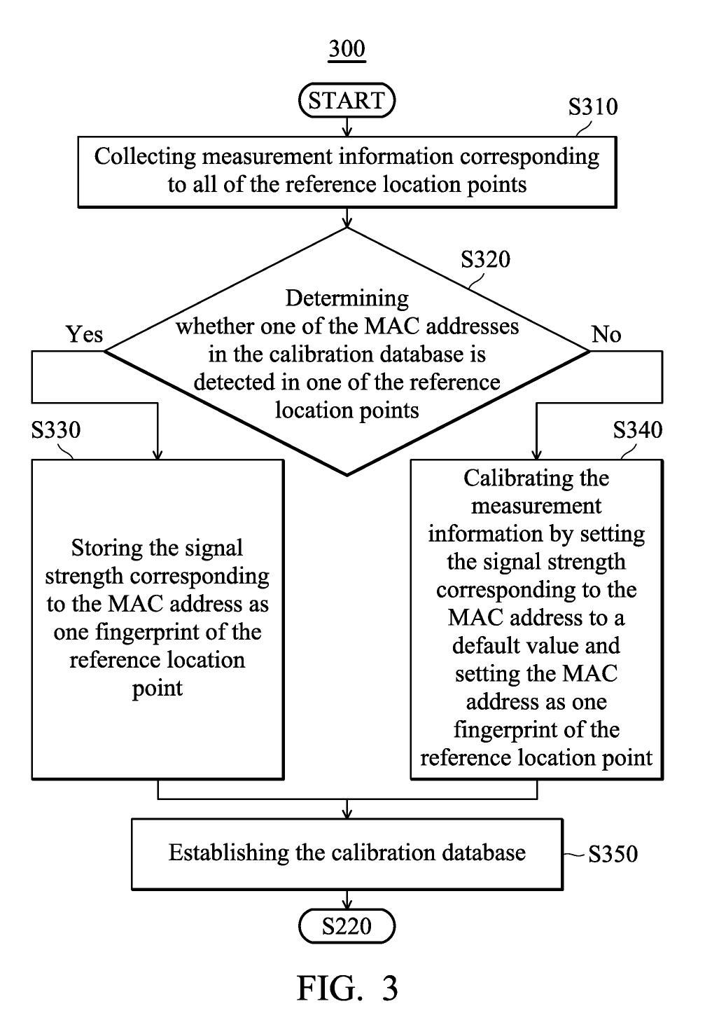

FIG. 3 is a flow chart 300 illustrating step S210 according to an embodiment of the invention. In step S310, the electronic device may collect measurement information corresponding to all of the reference location points. In step S320, the electronic device may determine whether one of the MAC addresses in the calibration database is detected at one of the reference location points. If the MAC address is detected at the reference location point, step S330 is performed. In step S330, the electronic device may store the signal strength corresponding to the MAC address as one fingerprint of the reference location point. If the MAC address is not detected in the reference location point, step S340 is performed. In step S340, the electronic device may modify the measurement information by setting the signal strength corresponding to the MAC address to a default value (e.g., −110 db) and setting the MAC address as one fingerprint of the reference location point. Steps S320, S330, and 340 may further be performed for other MAC addresses in the calibration database accordingly.

In step S350, the electronic device may establish the calibration database according to the measurement information (or the calibrated measurement information).

In an embodiment of the invention, the flow chart 300 may further comprise that the electronic device may remove data corresponding to one Wi-Fi access point from the calibration database 111 when the Wi-Fi access point is detected at partial reference location points and the number of partial reference location points is less than a threshold.

In an embodiment of the invention, the flow chart 300 may further comprise the electronic device removing data corresponding to one Wi-Fi access point from the calibration database 111 when the signal strength standard deviation of the Wi-Fi access point exceeds a threshold. It means that the variance of the signal strength measurements of the Wi-Fi access point at a reference point is too large, i.e. the signal strength of the Wi-Fi is not stable. Therefore, the electronic device may remove the data corresponding to the Wi-Fi access point from the calibration database 111.

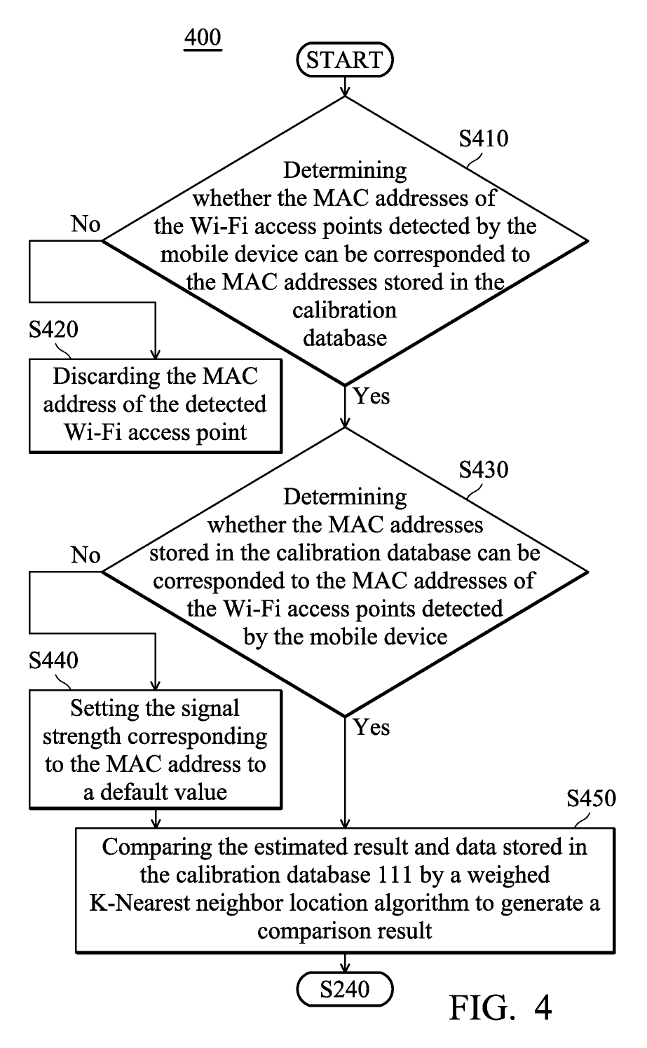

FIG. 4 is a flow chart 400 illustrating step S240 according to an embodiment of the invention. In step S410, the positioning terminal 130 may determine whether the MAC addresses of the Wi-Fi access points detected by the mobile device 120 correspond to the MAC addresses stored in the calibration database 111. If the MAC address of one of the detected Wi-Fi access points does not match any MAC address corresponding to all of the reference location points in the calibration database 111, step S420 is performed. In step S420, the positioning terminal 130 may discard the MAC address of the detected Wi-Fi access point.

After the determination of step S410 is performed for all of the MAC addresses of the detected Wi-Fi access points, Step S430 is performed. In step S430, the positioning terminal 130 may determine whether the MAC addresses stored in the calibration database 111 correspond to the MAC addresses of the Wi-Fi access points detected by the mobile device 120. If a MAC address corresponding to one of the reference location points is not detected, step S440 is performed. In step S440, the positioning terminal 130 may set the signal strength corresponding to the MAC address to a default value (e.g., −110 dB). In step S450, the positioning terminal 130 compares the estimated result and data stored in the calibration database 111 by a weighed K-Nearest neighbor location algorithm to generate a comparison result.

In an embodiment of the invention, the flow chart 400 may further comprise the positioning terminal 130 setting the signal strength corresponding to the MAC address to a default value (e.g., −110 dB), if a MAC address of one of the detected Wi-Fi access points does not match any MAC address corresponding to one of the reference location points but the MAC address corresponds to another reference location point.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying, and/or outputting as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A positioning method, comprising:
establishing, by at least one electronic device, a calibration database corresponding to an irregular grid of reference location points which are defined in an environment;
detecting, by a mobile device, Wi-Fi access points in the environment;
estimating, by the mobile device, signal strengths of the detected Wi-Fi access points to generate an estimated result;
comparing, by a positioning terminal, the estimated result and data stored in the calibration database by a weighed K-Nearest neighbor location algorithm to generate a comparison result; and
estimating, by a positioning terminal, a location of the mobile device according to the comparison result.

2. The positioning method of claim 1, wherein the electronic device is coupled to a Wi-Fi adapter.

3. The positioning method of claim 2, further comprising:
collecting, by the electronic device, measurement information corresponding to all of the reference location points from the Wi-Fi adapter; and
establishing the calibration database according to the measurement information.

4. The positioning method of claim 3, wherein the measurement information comprises time stamps, MAC addresses, and signal strengths.

5. The positioning method of claim 4, further comprising:
removing data corresponding to one Wi-Fi access point from the calibration database when the Wi-Fi access point is detected at partial reference location points and the number of partial reference location points is less than a threshold.

6. The positioning method of claim 4, further comprising:
removing data corresponding to one Wi-Fi access point from the calibration database when a signal strength standard deviation of the Wi-Fi access point exceeds a threshold.

7. The positioning method of claim 4, further comprising:
determining whether one of the MAC addresses in the calibration database is detected at one of the reference location points; and
storing the signal strength corresponding to the MAC address as one fingerprint of the reference location point if the MAC address is detected at the reference location point.

8. The positioning method of claim 7, further comprising:
calibrating the measurement information by setting the signal strength corresponding to the MAC address to a default value and setting the MAC address as one fingerprint of the reference location point if the MAC address is not detected at the reference location point.

9. The positioning method of claim 1, further comprising:
transforming the calibration database from the irregular grid of reference location points to a regular grid of reference location points using mathematical interpolation.

10. The positioning method of claim 1, wherein at least one of the Wi-Fi access points is configured to provide network connectivity.

11. The positioning method of claim 1, wherein a parameter K for the weighed K-Nearest neighbor location algorithm is set in a range from 4 to 8.

12. The positioning method of claim 1, wherein a separation distance for the weighed K-Nearest neighbor location algorithm is a Manhattan distance.

13. The positioning method of claim 1, wherein in the step of comparing the estimated result and the data stored in the calibration database, the positioning method further comprises:
determining whether a MAC address of one of the detected Wi-Fi access points matches any MAC address stored in the calibration database; and
discarding the MAC address of the detected Wi-Fi access point, if the MAC address does not match any MAC address stored in the calibration database.

14. The positioning method of claim 1, wherein in the step of comparing the estimated result and the data stored in the calibration database, the positioning method further comprises:
determining whether a MAC address stored in the calibration database is present in the estimated result; and
setting the signal strength corresponding to the MAC address to a default value for the mobile device, if the MAC address stored in the calibration database is not present in the estimated result.

15. The positioning method of claim 1, wherein in the step of comparing the estimated result and the data stored in the calibration database, the positioning method further comprises:
if a MAC address of one of the detected Wi-Fi access points does not match any MAC address corresponding to one of the reference location points but the MAC address corresponds to another reference location point, setting the signal strength corresponding to the MAC address to a default value for the mobile device.

16. A positioning system, comprising:
a storage device, storing a calibration database corresponding to an irregular grid of reference location points which are defined in an environment, wherein the calibration database is established by at least one electronic device in advance;
a mobile device, detecting Wi-Fi access points in the environment and estimating signal strengths of the detected Wi-Fi access points to generate an estimated result; and
a positioning terminal, comparing the estimated result and data stored in the calibration database by a weighed K-Nearest neighbor location algorithm to generate a comparison result and estimating a location for the mobile device according to the comparison result.

17. The positioning system of claim 16, wherein the electronic device is coupled to a Wi-Fi adapter.

18. The positioning system of claim 17, wherein the electronic device collects measurement information corresponding to all of the reference location points from the Wi-Fi adapter and establishes the calibration database according to the measurement information.

19. The positioning system of claim 18, wherein the measurement information comprises time stamps, MAC addresses, and signal strengths.

20. The positioning system of claim 19, wherein the electronic device further removes data corresponding to one Wi-Fi access point from the calibration database when the Wi-Fi access point is detected at partial reference location points and the number of partial reference location points is less than a threshold.

21. The positioning system of claim 19, wherein the electronic device further removes data corresponding to one Wi-Fi access point from the calibration database when a signal strength standard deviation of the Wi-Fi access point exceeds a threshold.

22. The positioning system of claim 19, wherein the electronic device further determines whether one of the MAC addresses in the calibration database is detected at one of the reference location points and if the MAC address is detected at the reference location point, the electronic device stores the signal strength corresponding to the MAC address as one fingerprint of the reference location point.

23. The positioning system of claim 22, wherein the electronic device calibrates the measurement information by setting the signal strength corresponding to the MAC address to a default value and setting the MAC address as one fingerprint of the reference location point if the MAC address is not detected at the reference location point.

24. The positioning system of claim 16, wherein the electronic device further transforms the calibration database from the irregular grid of reference location points to a regular grid of reference location points using mathematical interpolation.

25. The positioning system of claim 16, wherein at least one of the Wi-Fi access points is configured to provide network connectivity.

26. The positioning system of claim 16, wherein a parameter K for the weighed K-Nearest neighbor location algorithm is set in a range from 4 to 8.

27. The positioning system of claim 16, wherein a separation distance for the weighed K-Nearest neighbor location algorithm is a Manhattan distance.

28. The positioning system of claim 16, wherein the positioning terminal further determines whether a MAC address of one of the detected Wi-Fi access points matches any MAC address stored in the calibration database, and if the MAC address does not match any MAC address stored in the calibration database, the positioning terminal discards the MAC address of the detected Wi-Fi access point.

29. The positioning system of claim 16, wherein the positioning terminal further determines whether a MAC address stored in the calibration database is present in the estimated result, and if the MAC address stored in the calibration database is not present in the estimated result, the positioning terminal sets the signal strength corresponding to the MAC address to a default value for the mobile device.

30. The positioning system of claim 16, wherein if a MAC address of one of the detected Wi-Fi access points does not match any MAC address corresponding to one of the reference location points but the MAC address corresponds to another reference location point, the positioning terminal further sets the signal strength corresponding to the MAC address to a default value for the mobile device.
